(19) United States
(12) Patent Application Publication
(10) Pub. No.: US 2026/0192923 A1
(43) Pub. Date: Jul. 9, 2026

(54) CABIN EQUIPMENT UNIT AND METHOD FOR ASSEMBLING THE CABIN EQUIPMENT UNIT

(71) Applicant: FACC AG, Ried im Innkreis (AT)

(72) Inventor: BERNHARD KAMMERER, Zell an der Pram (AT)

(21) Appl. No.: 19/132,734

(22) PCT Filed: Nov. 24, 2023
(86) PCT No.: PCT/AT2023/060410

§ 371 Date: May 23, 2025

(30) Foreign Application Priority Data
Nov. 25, 2022 (AT) A 50896/2022

(51) Int. Cl. B64D 11/00; H01R 13/24; H01R 13/62

(52) U.S. Cl. CPC B64D 11/003; H01R 13/24; H01R 13/6205

(57) ABSTRACT

A cabin equipment unit for a passenger cabin, comprising: a first pivoting part, a second pivoting part pivotable relative to the first pivoting part about a pivot axis between an open position and a closed position, and an electric element arranged on the second pivoting part and connectable to the first pivoting part via an electrical connection line. The first pivoting part comprises a first contact connecting element, and the electrical connection line comprises a second contact connecting element corresponding to the first contact connecting element. The first and/or the second contact connecting element comprises a magnet. The contact connecting elements can be transferred from a separation position to a contact position. The second contact connecting element is arranged on the second pivoting part such that by moving the second pivoting part into the closed position, the contact connecting elements are brought into and held in the contact position.

### CROSS REFERENCE TO RELATED APPLICATIONS

The present application is a U.S. National Phase of International Application No. PCT/AT2023/060410 entitled “CABIN FITTING AND METHOD FOR ASSEMBLING THE CABIN FITTING,” and filed on Nov. 24, 2023. International Application No. PCT/AT2023/060410 claims priority to Austrian Patent Application No. A 50896/2022 filed on Nov. 25, 2022. The entire contents of each of the above-listed applications are hereby incorporated by reference for all purposes.

### TECHNICAL FIELD

The invention relates to a cabin equipment unit for a passenger cabin of an aircraft, in particular an overhead baggage compartment, wherein the cabin equipment unit comprises the following:
a first pivoting part, in particular a first baggage compartment part,
a second pivoting part which is pivotable relative to the first pivoting part about a pivot axis between an open position and a closed position, in particular a second baggage compartment part, and
an electric element arranged on the second pivoting part and connectable to the first pivoting part via an electrical connection line.

### BACKGROUND AND SUMMARY

Furthermore, the invention relates to an aircraft, in particular an airplane, with a passenger cabin and a cabin equipment unit, as well as to a method for assembling a cabin equipment unit, preferably in an aircraft, in particular in an airplane.

In the aviation industry, the objective is to utilize the available space as efficiently as possible; however, this increases the complexity of the components and makes their installation more difficult. This is also the case with cabin equipment units, such as overhead baggage compartments. In addition, these units include components such as joints, hinges, and electrical wiring, which for protection and safety reasons are arranged in concealed and therefore difficult-to-access places, in order to avoid wear and damage caused by loading and unloading baggage. In the case of baggage compartment parts that are pivotable relative to each other, electrical connection lines are therefore, for example, routed through the pivot axes and housed in cable ducts. This is shown, for example, in DE 10 2007 030 331 A1 or U.S. Pat. No. 10,407,172 B2. These measures, which serve safety and space savings, increase the installation effort of cabin equipment units in the aircraft cabin. It is therefore generally desirable to simplify the installation of cabin equipment units in airplanes without increasing space requirements or compromising safety.

From the prior art, magnetic coupling devices are known, with which a detachable electrical connection between electrical contacts can be established by means of magnets. If the coupling parts are sufficiently close to each other, they connect through magnetic force. Such couplings are known from U.S. Pat. No. 9,531,118 B2, EP 2 533 374 A1, EP 1 537 632 B1, and DE 20 2012 006 523 U1. However, the known magnetic coupling devices are not suitable for use in confined spaces such as those prevailing in cabin equipment units for airplanes, for example overhead baggage compartments. In particular, they cannot be used in places that cannot be reached by hand.

In light of the above explanations, it is an object of the present invention to eliminate or even completely avoid the disadvantages of the prior art. Preferably, it is an object of the present invention to simplify the creation of an electrical connection between the first and the second pivoting part in a cabin equipment unit of the type mentioned at the outset.

This object is achieved by a cabin equipment unit, an aircraft, and a method for assembling a cabin equipment unit as described herein.

According to the invention, in a cabin equipment unit of the type mentioned at the outset, it is provided that the first pivoting part comprises a first contact connecting element and the electrical connection line comprises a second contact connecting element corresponding to the first contact connecting element, wherein the first and/or the second contact connecting element comprises at least one magnet, and the contact connecting elements can be transferred from a separation position into a contact position in which the contact connecting elements are electrically connected to each other, wherein the second contact connecting element can be arranged on the second pivoting part in such a way that by moving the second pivoting part into the closed position, the contact connecting elements are brought into the contact position and held in the contact position, in particular by a magnetic force of the at least one magnet.

This advantageously makes it possible to establish an electrical connection between the first pivoting part and the second pivoting part in a difficult-to-access location during initial assembly or after a repair of the cabin equipment unit. Thus, even in the case of complex cabin equipment units, installation effort can be kept low. On the other hand, electrical connections can deliberately be placed in difficult-to-access locations in order to avoid damage, for example from loading baggage, and to keep the need for repair low. The cabin equipment unit can in particular be used in a passenger cabin of an airplane. Preferably, the cabin equipment unit is designed as an overhead baggage compartment mounted above seats in an airplane. However, the cabin equipment unit can also be a seat, a cabinet, a shelf, or interior paneling. The important point is only that two pivoting parts are provided. In the case of an overhead baggage compartment, the first pivoting part can be designed as the first baggage compartment part. Typically, the first baggage compartment part is static, i.e. immovable relative to the aircraft fuselage, and usually forms the top side of the overhead baggage compartment. The second baggage compartment part can preferably be pivoted downward relative to the first baggage compartment part. The cabin equipment unit preferably comprises a storage space for objects, in particular baggage, which can be loaded in the open position. In the closed position, the pivoting parts are preferably fixed relative to each other so that their position relative to each other remains the same. In one embodiment of the invention, the pivoting parts can be locked in the closed position. After actuating an actuating element, for example a handle, the second pivoting part can be moved into the open position. The electric element is an element that is to be supplied with electrical current via the electrical connection line. The connection line can also transmit signals, in particular data signals. Preferably, the connection line is an electrical cable that is insulated. The cable comprises at least two mutually insulated conductors, preferably at least three or at least four conductors. For example, the connection line may comprise two conductors for the power supply and at least one or more conductors for (data) signals. The electric element may be an electric lighting element, an electric motor, a monitor, or a control panel. According to the invention, the first pivoting part comprises a first contact connecting element, and the electrical connection line comprises a second contact connecting element corresponding to the first contact connecting element. Corresponding means that the contact elements can be connected to each other. Via the contact connecting elements, an electrical connection can be established between the electric element and the first pivoting part. For this purpose, the contact connecting elements can each comprise corresponding contacts, for example contact pins and/or contact sockets. The contacts, in particular contact pins, can be spring-preloaded by means of mechanical springs to facilitate electrical contacting. The contact sockets can also be spring-preloaded and/or have springy side walls to releasably fix contact pins. Preferably, the first and the second contact connecting element each comprise at least two, at least three, or at least four contacts. In the contact position, the contacts of the contact connecting elements make electrical contact with each other. The first pivoting part can comprise an electrical power supply or be connected to one. The first contact connecting element can be connected to the power supply by means of an additional connection line. In order to create and, in a preferred embodiment, also maintain the contact position, the first and/or the second contact connecting element comprises at least one magnet. The magnet can be, for example, a permanent magnet, for instance a permanent magnet made of neodymium or a neodymium-iron-boron compound, an electromagnet, or a pre-magnetized material, for example pre-magnetized metal. In the case of a permanent magnet, it can, for example, be designed as a rod magnet. By means of the at least one magnet, the contact connecting elements are attracted to each other when the contact connecting elements are at a sufficiently small distance from each other, for example less than 2 cm. If only one of the contact connecting elements comprises a magnet, then at least part of the other contact connecting element is made of a magnetic material, in particular metal. Of course, both contact connecting elements can also comprise correspondingly oriented and polarized magnets. In a preferred embodiment, the first or the second contact connecting element comprises projecting positioning pins that can be received in corresponding receiving sockets in the other of the first or second contact connecting element, preferably in an essentially form-fitting manner. The positioning pins can be conically shaped to facilitate insertion into the receiving sockets. It is preferred if the positioning pins comprise magnets. It can also be provided that the receiving sockets comprise magnets and the other contact connecting element comprises positioning pins without magnets, which can be inserted into the receiving sockets. Preferably, the contact pins project from the corresponding contact connecting element with a shorter length than the positioning pins, so that the positioning pins can position the contact connecting elements before the contact pins enter the contact sockets. In the separation position, the contacts of the contact connecting elements are electrically separated from each other, so there is no electrical connection between the electric element and the first pivoting part. The contact connecting elements can be transferred from the contact position to the separation position, in particular by overcoming the magnetic force. The first contact connecting element can be mounted statically, i.e. immovably, on the first pivoting part, for example by bonding, riveting, welding, or screwing. Preferably, the first contact connecting element is arranged on an inside of the cabin equipment unit, in particular on an inside of the first pivoting part that forms or faces a receiving space for the second pivoting part. The first contact connecting element can be arranged essentially flush with the inside of the first pivoting part. The first contact connecting element can also be arranged offset relative to that inside. The second contact connecting element can be arranged detachably on the second pivoting part such that, when the second pivoting part is moved into the closed position, the contact connecting elements are brought into the contact position by the magnetic force of the at least one magnet. For this purpose, the second contact connecting element can be held on the second pivoting part in a tool-free detachable manner. When the second pivoting part is moved into the closed position and thus brought closer to the first pivoting part, the second contact connecting element is also brought closer to the first contact connecting element. If the distance between the contact connecting elements is small enough—e.g., less than 2 cm—the second contact connecting element is attracted by the first contact connecting element magnetically, or vice versa. The second contact connecting element is arranged on the second pivoting part in such a way that it can become detached from the second pivoting part and enter the contact position with the first contact connecting element. Preferably, the contact connecting elements are shaped so that there is a unique orientation for the contact position, ruling out faulty electrical contact. The at least one magnet can be oriented so that the contact elements find the contact position in the prescribed orientation. The magnet holds the contact connecting elements in the contact position. Additionally, a tool-free detachable mechanical lock, such as a spring-loaded snap element, may be provided to hold the contact connecting elements in the contact position. This embodiment is particularly advantageous when using an electromagnet. The contact connecting elements can be configured to transmit electrical energy and data signals. The first and/or second contact connecting element can be made at least partially of plastic, for example polyetherimide.

In this disclosure, directional and positional information refers to the intended installation state of the cabin equipment unit in a passenger cabin of an aircraft, in particular an airplane. In a non-limiting example, the intended installation state of an overhead baggage compartment is, for instance, one in which the second baggage compartment part can be pivoted downward. The pivot axis is preferably aligned essentially parallel to the longitudinal axis of the aircraft or the passenger cabin.

It is preferred that the contact position between the first and the second contact connecting element remains maintained when the second pivoting part is moved from the closed position to the open position. This can be achieved by means of the at least one magnet, which holds the contact connecting elements in the contact position in a detachable manner. As mentioned above, a tool-free detachable mechanical lock, for example a spring-loaded snap element, can additionally be provided to hold the contact connecting elements in the contact position.

In a particularly preferred embodiment of the invention, a positioning element, in particular a holding element, for the second contact connecting element is arranged on the second pivoting part, by means of which the second contact connecting element can be brought toward the first contact connecting element when the second pivoting part is moved into the closed position. By means of the positioning element, the second contact connecting element can be positioned at a location on the second pivoting part from which the second contact connecting element can be brought into contact with the first contact connecting element by means of the at least one magnet when the second pivoting part is moved into the closed position. The positioning element is designed to hold the second contact connecting element in a tool-free detachable manner, so that the second contact connecting element can detach itself from the positioning element when it transitions into the contact position with the first contact connecting element. In one embodiment of the invention, the positioning element can comprise at least one, in particular several, retaining projections that can hold the second contact connecting element in position. In doing so, there can be a clearance, for example of less than 1 mm, between the at least one retaining projection and the second contact connecting element. The positioning element can be made at least partly or entirely of a plastic, such as polyetherimide. It is advantageous to use flame-retardant plastics. The positioning element can be produced by means of an injection molding process. Preferably, the positioning element is arranged on an outer side, in particular on an upper outer side, of the second pivoting part.

To make it easier to bring the contact connecting elements into the contact position, it is advantageous for the positioning element to be arranged at essentially the same distance from the pivot axis in a cross-section of the cabin equipment unit as the first contact connecting element. It is also advantageous if, viewed in a longitudinal section of the cabin equipment unit, the positioning element and the contact connecting element are arranged at essentially the same longitudinal position. This allows the positioning element to be brought precisely toward the first contact connecting element when the pivoting parts are moved into the closed position.

In one embodiment of the invention, the first pivoting part can form a receiving space into which the second pivoting part is at least partially inserted in the closed position, wherein the first contact connecting element is arranged on an inside of the first pivoting part that forms the receiving space. This embodiment of the invention is particularly advantageous for overhead baggage compartments, as it allows an electrical connection of the two pivoting parts to be made in a location that is difficult to access. By arranging the electrical connection at a location that is difficult to access, the electrical connection is protected from damage. This also increases safety for persons.

In the aforementioned embodiment, as already mentioned, it is additionally advantageous if the positioning element is arranged on an outer side, in particular on an upper outer side, of the second pivoting part facing the receiving space. By thus moving the second pivoting part into the closed position, an electrical connection between the electric element and the first pivoting part can be established at a location that is difficult to access but protected.

The connection line can be arranged at least partially in a portion of the receiving space. Preferably, the portion is located between the upper outer side of the second pivoting part and the inside of the first pivoting part facing the receiving space.

Regarding space savings, it is advantageous if the connection line is a flat ribbon cable, in particular a flat ribbon cable with at least four poles. The flat ribbon cable may have, for example, a length of at least 4 cm. The individual conductors of the cable are electrically insulated from each other.

In one embodiment of the invention, the electric element is a lighting element, in particular one arranged in a handle strip of the second pivoting part. The electrical connection of the electric element to the first pivoting part can be established by the electrical connection line. However, the electric element can also be a monitor, an electric motor, or a control element.

To facilitate establishing an electrical connection, it is advantageous if the first and/or second contact connecting element comprises at least one spring-loaded contact pin. The at least one spring-loaded contact pin can be spring-preloaded. A contact pin on the first or second contact connecting element can be inserted into a contact socket on the other of the first or second contact connecting element. The contact socket can also be spring-loaded in design. Preferably, side walls of the contact sockets are formed to be spring-loaded. Preferably, the first/second contact connecting element only comprises contact pins, while the second/first contact connecting element only comprises contact sockets, each of which can receive a contact pin. Preferably, the contact pins and contact sockets are arranged in such a way that there is only a single orientation of the contact connecting elements in which the contact connecting elements can be brought into the contact position.

To prevent unintentional pulling on the connection line during the deinstallation of the cabin equipment unit, a securing element can be provided that is connected to the second contact connecting element and to the second pivoting part. For example, the securing element can be designed as a wire, cable, cord, or chain. The securing element is preferably dimensioned in such a way that, during a disassembly of the second pivoting part, the second contact connecting element is pulled off the first contact connecting element without placing a load on the connection line, so that the contact connecting elements are transferred to the separation position by the securing element. As a result, the connection line is not placed under stress. For example, it can be provided that the securing element is shorter than the section of the connection line located in the portion of the receiving space between the first and the second pivoting part. The securing element can be fastened to the second pivoting part, for example to the positioning element or a holder, in particular a hook element.

The object mentioned at the outset is also achieved by an aircraft, in particular an airplane, as described herein. The aircraft according to the invention comprises at least one cabin equipment unit of the type described above. The cabin equipment unit is arranged in the passenger cabin. Preferably, multiple cabin equipment units are present in the passenger cabin.

The object mentioned at the outset is also achieved by a method for assembling a cabin equipment unit, preferably in an aircraft, in particular in an airplane, as described herein. The method comprises the following steps:

Providing a cabin equipment unit, which comprises:
a first pivoting part, in particular a first baggage compartment part, with a first contact connecting element;
a second pivoting part, which is pivotable relative to the first pivoting part about a pivot axis, in particular a second baggage compartment part;
an electric element arranged on the second pivoting part and connectable to the first pivoting part via an electrical connection line, wherein the electrical connection line comprises a second contact connecting element corresponding to the first contact connecting element, and the second contact connecting element is arranged detachably on the second pivoting part;
at least one magnet on the first and/or second contact connecting element, wherein the contact connecting elements can be transferred from a separation position into a contact position in which the contact connecting elements are electrically connected to each other;

Moving the second pivoting part into a closed position, so that the contact connecting elements are brought into the contact position and then held in the contact position, in particular by a magnetic force of the at least one magnet.

The method is thus suitable for assembling a cabin equipment unit of the type described above. The advantages and features described in connection with the cabin equipment unit can therefore be transferred to the method. Advantageously, by means of the method according to the invention, an electrical connection between the electric element and the first pivoting part in a difficult-to-access but thereby protected location can be established in a simple manner. During the deinstallation of the cabin equipment unit, for instance in the context of replacement or repair work, the electrical connection can be released again by overcoming the magnetic force and thereby moving the contact connecting elements into the separation position.

In one embodiment of the invention, it is provided that before moving the second pivoting part into the closed position, the second pivoting part is connected to the first pivoting part and the second contact connecting element is arranged detachably on the second pivoting part. For this purpose, the second contact connecting element can be inserted into the positioning element.

### BRIEF DESCRIPTION OF THE FIGURES

The invention will be described in the following with reference to the figures, but is not limited thereto. In the figures:

FIG. 1 shows a cabin equipment unit for a passenger cabin in a closed position;

FIG. 2 shows a cabin equipment unit for a passenger cabin in an open position;

FIG. 3A, FIG. 3B, and FIG. 3C show a movement sequence of a cabin equipment unit from a closed position to an open position.

FIG. 4A shows a detail of a cross-section of a cabin equipment unit for a passenger cabin, in which contact elements are in a separation position;

FIG. 4B shows a detail of a cross-section of the cabin equipment unit according to FIG. 4A, in which the contact elements are in a contact position;

FIG. 5 shows a detail of a cross-section of a cabin equipment unit for a passenger cabin, in which contact elements are in a separation position;

FIG. 6 shows a first contact connecting element;

FIG. 7 shows a second contact connecting element in a positioning element;

FIG. 8 shows a positioning element in a perspective view and in cross-section;

FIG. 9 shows a first and a second contact connecting element in a contact position in cross-section;

FIG. 10 shows a second contact connecting element in a positioning element in a plan view; and

FIG. 11 shows a second contact connecting element with a securing element.

### DETAILED DESCRIPTION

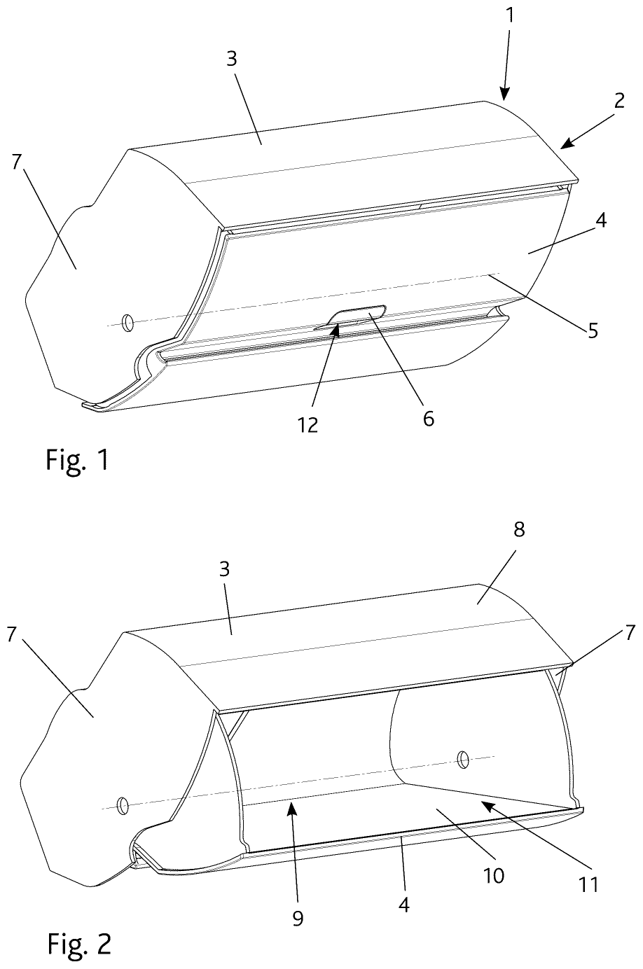

FIG. 1 shows a cabin equipment unit 1 for a passenger cabin of an airplane (not shown) in a closed position, which in the illustrated embodiment is designed as an overhead baggage compartment 2. The cabin equipment unit 1 comprises a first pivoting part 3 and a second pivoting part 4, which can pivot relative to the first pivoting part 3 about a pivot axis 5. After actuating the handle 6, the cabin equipment unit 1 can be moved from the closed position to an open position (see FIG. 2), in which the cabin equipment unit 1 can be loaded, for example, with items of baggage (not shown). In the intended installation state, the cabin equipment unit 1 can be arranged in an airplane, in particular above passenger seats, by means of fastening devices (not shown).

As shown in FIG. 2, the first pivoting part 3 has two opposing side surfaces 7 and an upper cover surface 8. Between the side surfaces 7 and the cover surface 8, the first pivoting part 3 forms a receiving space 9 in which the second pivoting part 4 is at least partially received. In the illustration shown, the second pivoting part 4 is designed as a chute 10 that comprises a storage space 11 for items of baggage (not shown). By swinging the second pivoting part 4 upward about the pivot axis 5, the cabin equipment unit 1 can be brought into the closed position (see FIG. 1), in which the items of baggage are stored. In the closed position, the cabin equipment unit 1 is held by a locking mechanism (not shown). The lock can be released by means of the handle 6, in order to move the cabin equipment unit 1 from the closed position back to the open position.

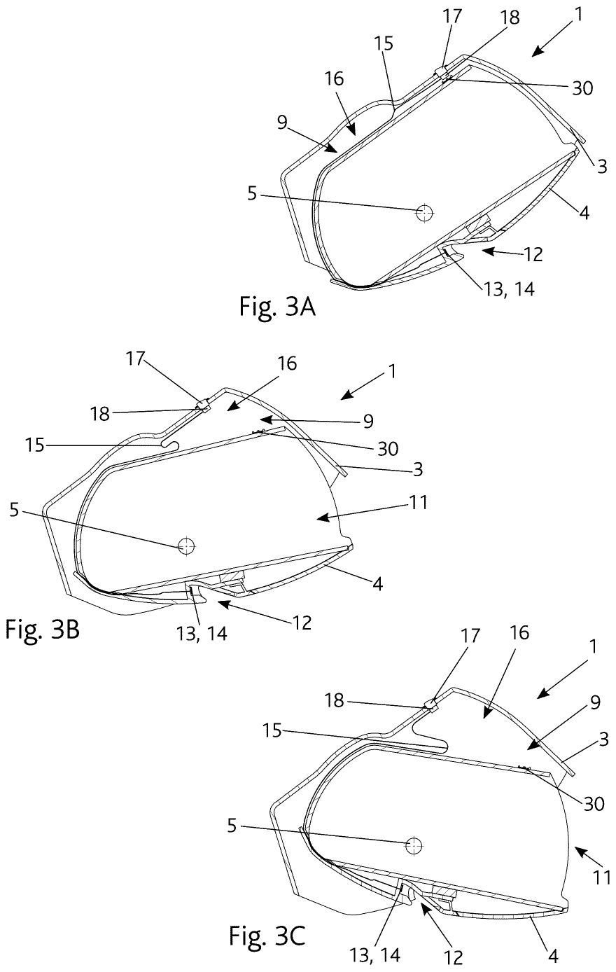

FIGS. 3A-C show moving the cabin equipment unit 1 from the closed position to the open position in a cross-sectional view. As can be particularly seen in FIGS. 3A-C, in a recess 12 of the second pivoting part 4, in which the handle 6 is also received, an electric element 13 is provided in the form of a lighting element 14. The lighting element can comprise one or more light elements, such as LEDs. The recess 12 and the handle 6 can also be referred to as a handle strip. Of course, additional or other electric elements 13 such as control panels, electric motors, or screens can also be present on the second pivoting part 4. To supply power to the electric element 13, an electrical connection line 15 is provided that electrically connects the electric element 13 to the first pivoting part 3. The connection line 15 can also transmit data signals. For example, two poles of the connection line may serve for the power supply, and at least one or more poles may serve for data transmission. The electrical connection line 15 can be a flat ribbon cable. In order to avoid damage to the first connection line 15 caused by loading the cabin equipment unit 1 with items of baggage, the electrical connection line 15 is arranged at least partly in an intermediate space 16, which forms part of the receiving space 9. In the illustration shown, the electrical connection line 15 runs partly inside the second pivoting part 4 and finally via the receiving space 16 to the first pivoting part 3. This is the case both in the closed position and in the open position.

Arranging the connection line 15 in the intermediate space 16 prevents damage to the connection line 15 while also simplifying the structure of the cabin equipment unit 1, since the connection line 15 need not, for example, be routed through the pivot axis 5. However, as can be seen especially in FIGS. 3A-C, the intermediate space 16 is difficult to access during assembly or installation.

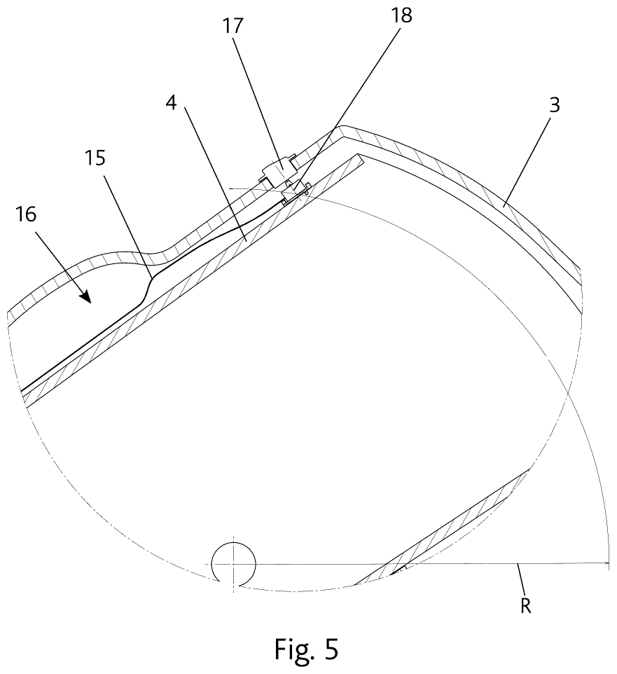

According to the invention, therefore, a first contact connecting element 17 is provided on the first pivoting part 3, and a second contact connecting element 18 on one end of the connection line 15. The first 17 and the second contact connecting element 18 can be transferred from a separation position, in which the contact connecting elements 17, 18 are neither electrically nor mechanically connected to each other, to a contact position in which the contact connecting elements 17, 18 are electrically connected to each other. In order to connect the contact connecting elements 17, 18 to each other more easily, i.e. bring them into the contact position, at least one magnet 19, especially a permanent magnet, can be provided. To simplify installation of the cabin equipment unit 1, during assembly it is intended that the second contact connecting element 18 is arranged on the second pivoting part 4 in such a way that, by moving the second pivoting part 4 into the closed position, the contact connecting elements 17, 18 are brought into the contact position. By moving the second pivoting part 4 into the closed position, the second contact connecting element 18 is brought close to the first contact connecting element 17. Thereby, the contact connecting elements 17, 18 are attracted to each other by the magnetic force of the at least one magnet 19 and brought into and held in the contact position. The second contact connecting element 18 is placed in such a way that magnetic attraction by the magnet 19 is made possible when the second pivoting part 4 is moved into the closed position. In the figures shown, the first contact connecting element 17 is arranged on an inside of the first pivoting part 3 facing the receiving space 9. The second contact connecting element 18 is arranged on an upper outer side of the second pivoting part 4 facing the receiving space 9. Preferably, the second contact connecting element 18, before being moved to the contact position, is arranged at essentially the same distance R from the pivot axis 5 (see FIG. 5) when viewed in a cross-section of the cabin equipment unit 1 as the first contact connecting element 17.

FIG. 3A shows the second pivoting part 4 in the closed position, causing the contact connecting elements 17, 18 to be brought into the contact position. Even if the second pivoting part 4 is moved to the open position, the contact connecting elements 17, 18 remain in the contact position, as shown in FIGS. 3B and 3C.

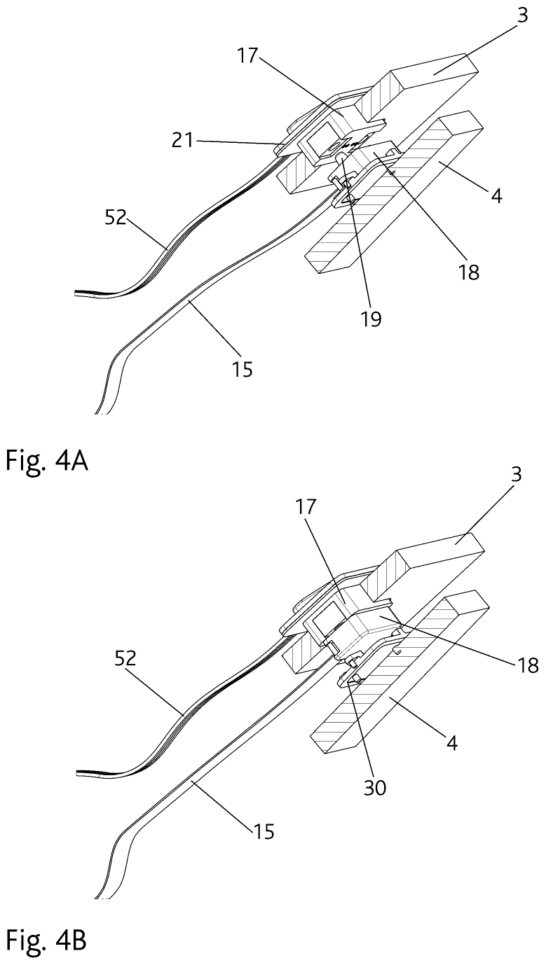

FIG. 4A shows a detail of a cross-section of the cabin equipment unit 1, in which the second pivoting part 4 is already in the closed position but the contact connecting elements 17, 18 are still in the separation position. By means of the magnetic force of the at least one magnet 19, the second contact connecting element 18 detaches from its position on the second pivoting part 4 and is pulled in the direction of the first contact connecting element 17, and the two contact connecting elements automatically reach the contact position (FIG. 4B). The at least one magnet 19 holds the contact connecting elements 17, 18 in the contact position. The contact connecting elements can be moved back to the separation position by overcoming the magnetic force, for example, during disassembly in the context of repair work. In normal use in an airplane, however, the contact position remains in place even if the second pivoting part 4 is moved from the closed position to the open position.

FIG. 5 shows an enlarged section of the cross-section according to FIG. 4A, in which the second pivoting part 4 is in the closed position, but the second contact connecting element 18 has not yet been pulled by the magnetic force of the magnet 19 in the direction of the first contact connecting element 17.

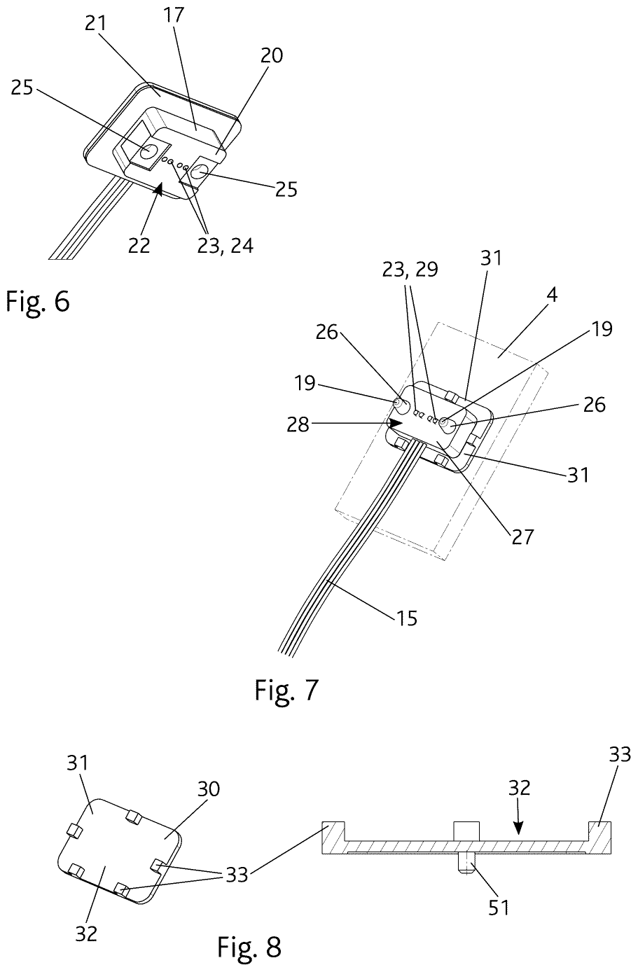

FIG. 6 shows a first contact connecting element 17 in an enlarged view. The first contact connecting element 17 comprises a first base body 20, which is preferably essentially cuboid in shape. A preferably circumferential holding flange 21 is provided on a rear side of the first base body 20, facilitating its installation in the first pivoting part 4. On a front side 22 of the first base body 20, the first contact connecting element 17 comprises several contacts 23 in the form of contact sockets 24. The contact sockets 24 are designed to receive contact pins 29 of the second contact connecting element 18. In the illustrated embodiment, the contacts 23 are arranged along a straight line, although they can also be positioned differently. The first base body 20 has two receiving sockets 25, which in the illustration shown are located near the narrow sides of the first base body 20. The receiving sockets 25 are designed to receive, preferably in an essentially form-fitting manner, projecting positioning pins 26 of the second contact connecting element 18. At least one magnet 19 can be provided in the receiving sockets 25. Another connection line 52 leads from the first contact connecting element 17 to a power supply (not shown).

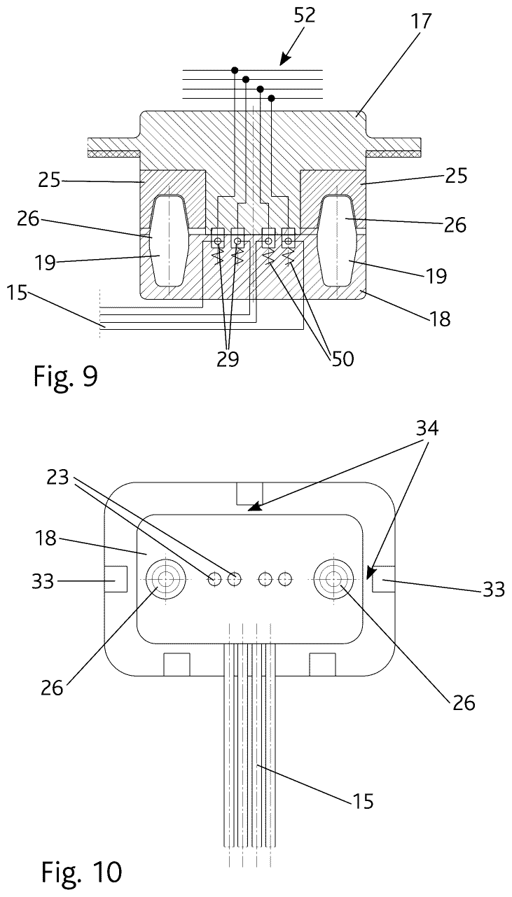

FIG. 7 shows a second contact connecting element 18 in an enlarged view. The second contact connecting element 18 comprises a second base body 27, which is preferably essentially cuboid in shape. On a front side 28 of the second base body 27, the first contact connecting element 17 comprises several contacts 23 in the form of contact pins 29. The contact pins 29 can be inserted into the contact sockets 24. In the illustrated embodiment, the contact sockets 24 are also arranged along a straight line, but can likewise be arranged differently. The important point is only that the arrangement pattern of the contact pins 29 corresponds to the arrangement pattern of the contact sockets 24. The contact pins 29 can be spring-preloaded by means of springs 50 (see FIG. 9) to improve electrical contact. The contacts 23 are arranged along a straight line, but could also be positioned differently. The connection line 15 leads into the second base body 27 and is connected there to the contacts 23. The second base body 27 comprises two projecting positioning pins 26, which in the illustration shown are arranged near the narrow sides of the second base body 27. The positioning pins 26 can project from the surface of the second base body 27 by a length between 0.5 mm and 5 mm in one embodiment. Preferably, the contact pins 29 project from the surface of the second base body 27 with a shorter length than the positioning pins 26. The contact pins 29 can be spring-preloaded (see below), with each contact pin 29 having, for example, a spring travel between 0.1 mm and 4 mm. This allows a positioning of the contact connecting elements 17, 18 to be carried out before the contact pins 29 are received in the contact sockets 24. The positioning pins 26 can be received by the receiving sockets 25. The positioning pins 26 can comprise at least one magnet 19.

It should be noted here that the design of the first 17 and second contact connecting elements 18 can also be interchanged. For example, the first contact connecting element 17 can have projecting positioning pins 26 and/or contact pins 29, and the second contact connecting element 18 can have contact sockets 24 and/or receiving sockets 25.

In FIG. 7, it can be seen that the second contact connecting element 18 is arranged in a positioning element 30, in the form of a holding element 31, in a tool-free detachable manner. FIG. 8 shows the positioning element 30 in an enlarged view, and also in cross-section. The positioning element 30, which can be connected to the second pivoting part 4, facilitates the exact positioning of the second contact connecting element 18 on the second pivoting part 4, so that by moving the second pivoting part 4 into the closed position, it can be brought toward the first contact connecting element 17 so that the at least one magnet 19 can bring the contact connecting elements 17, 18 into the contact position. The positioning element 30 comprises an essentially rectangular support surface 32, on which retaining projections 33 are preferably arranged along the circumference of the positioning element 30. The positioning element 30 is preferably dimensioned such that when the second contact connecting element 18 is received in the positioning element 30, a clearance 34 is provided between the second contact connecting element 18 and the retaining projections 33 (see FIG. 10). One or more fixing pins 51 may be located on the rear side of the positioning element 30 for fastening the positioning element 30 to the second pivoting part 4.

FIG. 9 shows a first 17 and a second contact connecting element 18 in the contact position in a cross-sectional view. It can be seen that the contact pins 29 are spring-preloaded by means of springs 50, thus avoiding errors in electrical contacting. It is also apparent that the positioning pins 26 taper conically toward an end projecting from the second base body 27, facilitating their insertion into the receiving sockets 25.

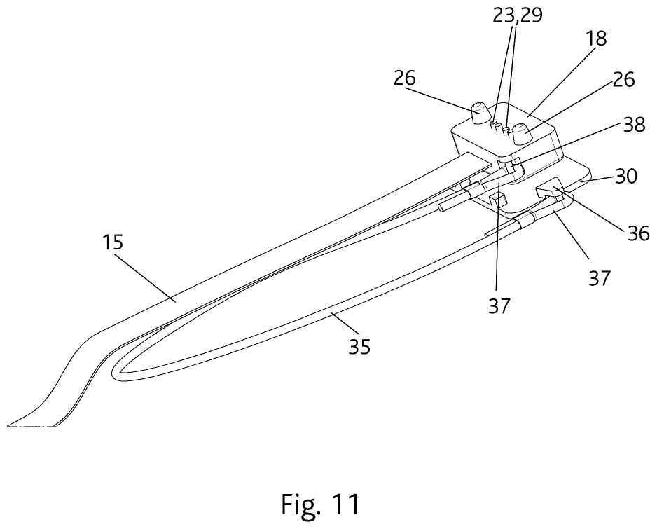

FIG. 11 shows an embodiment of the invention in which a securing element 35 in the form of a cord is provided. The securing element 35 is connected to the second pivoting part 4 and to the second contact connecting element 18. In the illustrated embodiment, the securing element 35 is attached to a hook element 36 of the positioning element 30. Alternatively, however, the hook element 36 can, for example, be attached directly to the second pivoting part. On the second contact connecting element 18, the securing element 35 is connected to a safety bar 38. At both ends, the securing element 35 forms a loop 37 for fastening. The securing element 35 prevents a tensile force from being applied to the connection line 15 when the cabin equipment unit 1 is disassembled, in particular when the second pivoting part 4 is removed from the first pivoting part 3. If the second pivoting part 4 is removed, a tensile force is exerted on the second contact connecting element 18 via the securing element 35, thereby transferring the contact connecting elements to the separation position.

1. A cabin equipment unit for a passenger cabin of an aircraft, comprising:
a first pivoting part,
a second pivoting part, which is pivotable relative to the first pivoting part about a pivot axis between an open position and a closed position, and
an electric element arranged on the second pivoting part and connectable to the first pivoting part via an electrical connection line,
wherein the first pivoting part comprises a first contact connecting element and the electrical connection line comprises a second contact connecting element corresponding to the first contact connecting element, wherein the first and/or the second contact connecting element comprises at least one magnet, and the first contact connecting element and the second contact connecting elements are transferrable from a separation position to a contact position in which the first contact connecting element and the second contact connecting elements are electrically connected to each other, wherein the second contact connecting element is arrangeable on the second pivoting part such that by moving the second pivoting part into the closed position, the first contact connecting element and the second contact connecting elements are brought into the contact position and held in the contact position.

2. The cabin equipment unit according to claim 1, wherein the contact position between the first contact connecting element and the second contact connecting element is maintained when the second pivoting part is moved from the closed position to the open position.

3. The cabin equipment unit according to claim 1, wherein a positioning element for the second contact connecting element is arranged on the second pivoting part, by means of which the second contact connecting element can be brought toward the first contact connecting element when the second pivoting part is moved into the closed position.

4. The cabin equipment unit according to claim 3, wherein the positioning element, viewed in a cross-section of the cabin equipment unit, is arranged at essentially the same distance from the pivot axis as the first contact connecting element.

5. The cabin equipment unit according to one of claim 1, wherein the first pivoting part forms a receiving space into which the second pivoting part is at least partially inserted in the closed position, wherein the first contact connecting element is arranged on an inside of the first pivoting part forming the receiving space.

6. The cabin equipment unit according to claim 5, wherein a positioning element for the second contact connecting element is arranged on an outside, of the second pivoting part facing the receiving space.

7. The cabin equipment unit according to claim 5, wherein the electrical connection line is at least partially arranged in a portion of the receiving space.

8. The cabin equipment unit according to claim 1, wherein the electrical connection line is a flat ribbon cable.

9. The cabin equipment unit according to claim 1, wherein the electric element is a lighting element.

10. The cabin equipment unit according to claim 1, wherein the first contact connecting element and/or the second contact connecting element comprises at least one spring-loaded contact pin.

11. The cabin equipment unit according to claim 1, wherein a securing element is provided which is connected to the second contact connecting element and to the second pivoting part.

12. An aircraft with at least one cabin equipment unit arranged in a passenger cabin, wherein the cabin equipment unit is designed according to claim 1.

13. A method for assembling a cabin equipment unit with the following steps:
providing a cabin equipment unit, which comprises:
a first pivoting part with a first contact connecting element;
a second pivoting part, which is pivotable relative to the first pivoting part about a pivot axis;
an electric element arranged on the second pivoting part and connectable to the first pivoting part via an electrical connection line, wherein the electrical connection line comprises a second contact connecting element corresponding to the first contact connecting element, and the second contact connecting element is arranged detachably on the second pivoting part; and
at least one magnet on the first contact connecting element and/or the second contact connecting element, wherein the first contact connecting element and the second contact connecting element, can be transferred from a separation position to a contact position in which the first contact connecting element and the second contact connecting elements are electrically connected to each other; and
moving the second pivoting part into a closed position, so that the first contact connecting element and the second contact connecting elements are brought into the contact position and subsequently held in the contact position.

14. The method according to claim 13, wherein before moving the second pivoting part into the closed position, the second pivoting part is connected to the first pivoting part and the second contact connecting element is arranged detachably on the second pivoting part.

15. The cabin equipment unit of claim 1, wherein the first contact connecting element and the second contact connecting element are brought into the contact position and held in the contact position by a magnetic force of the at least one magnet.

16. The cabin equipment unit of claim 1, wherein the cabin equipment unit is an overhead baggage compartment.

17. The cabin equipment unit of claim 6, wherein the positioning element is arranged on an upper outside of the second pivoting part.

18. The cabin equipment unit of claim 8, wherein the flat ribbon cable has at least four poles.

19. The cabin equipment unit of claim 9, wherein the lighting element is arranged in a handle strip of the second pivoting part.

20. The cabin equipment unit of claim 11, wherein the securing element is a cable, a wire, or a cord.
